(19) United States
(12) Patent Application Publication
(10) Pub. No.: US 2018/0329884 A1
(43) Pub. Date: Nov. 15, 2018

(54) NEURAL CONTEXTUAL CONVERSATION LEARNING

(71) Applicant: RSVP Technologies Inc., Waterloo (CA)

(72) Inventors: Kun Xiong, Waterloo (CA); Anqi Cui, Waterloo (CA); Zefeng Zhang, Waterloo (CA); Ming Li, Waterloo (CA)

(21) Appl. No.: 15/594,137

(22) Filed: May 12, 2017

(51) Int. Cl. G06F 17/27; G06N 3/04; G06N 3/08

(52) U.S. Cl. CPC G06F 17/2785; G06N 3/0445; G06F 17/271; G06N 3/08; G06N 3/0454

(57) ABSTRACT

A computer-implemented apparatus is provided for generating a response string based at least on a received inquiry string using a recurrent neural network (RNN) encoder-decoder architecture, the apparatus comprising: a first RNN configured to receive the inquiry string as a sequence of vectors x and to encode a sequence of symbols into a fixed length vector representation, vector c; a contextual neural network (CNN) for inferring topic distribution from a training set having a plurality of training questions and a plurality of training labels, the CNN configured to extract word features, compute syntactic features and infer semantic representation based on interconnections derived from the training set to generate a fixed length topic vector representation of a probability distribution in a topic space, the topic space inferred from a concatenated utterance of historical conversation; and a second RNN used as a RNN contextual decoder for estimating a conditional probability distribution of a plurality of responses.

### FIELD

The present disclosure generally relates to the field of linguistics processing, specifically relating to labeled question-answering pairs.

### INTRODUCTION

Neural conversational approaches tend to produce generic or safe responses in different contexts, e.g., reply “Of course” to narrative statements or “I don't know” to questions.

Improved neural conversational approaches are desirable.

### SUMMARY

In various further aspects, the disclosure provides corresponding systems and devices, and logic structures such as machine-executable coded instruction sets for implementing such systems, devices, and methods.

In an aspect, there is provided a computer-implemented apparatus for generating a response string based at least on a received inquiry string using a recurrent neural network (RNN) encoder-decoder architecture to improve a relevancy of the generated response string by adapting the generated response based on an identified probabilistic latent conversation domain, the apparatus comprising: a first RNN configured to receive the inquiry string as a sequence of vectors x and to encode a sequence of symbols into a fixed length vector representation, vector c; a contextual neural network (CNN) for inferring topic distribution from a training set having a plurality of training questions and a plurality of training labels, the CNN configured to extract word features, compute syntactic features and infer semantic representation based on interconnections derived from the training set to generate a fixed length topic vector representation of a probability distribution in a topic space, the topic space inferred from a concatenated utterance of historical conversation; and a second RNN used as a RNN contextual decoder for estimating a conditional probability distribution of a plurality of responses, the second RNN configured to: receive the vector c and the fixed length topic vector representation of the probability distribution in a topic space; apply a layered gated-feedback mechanism arranged in a context-attention architecture to recursively apply a transition function to one or more hidden states for each symbol of the vector c; estimate a conditional probability of the received inquiry string and generate the response string based at least on the estimated conditional probability.

In another aspect, the CNN is an encoder including at least a convolutional layer with multiple filters, a K-max pooling layer, a convolutional layer capturing sequential features, a max-over-time pooling layer, and a fully connected layer.

In another aspect, the context-attention architecture provides a gated layer where a gated hidden unit is applied having the relation:

\ddot{h}ₜ(1−zₜ)∘hₜ+zₜ∘\tilde{h}ₜ

where,

\tilde{h}ₜ=tanh(Wₕ[rₜ∘hₜ]+W_{ch}^{h}cₕ)

zₜ=σ(W_{z}sₜ+W_{ch}^{z}cₕ)

rₜ=σ(Wᵣsₜ+W_{ch}^{r}cₕ), and

Wₕ,W_{z},Wᵣ∈ [symbol] ^{n×n} and W_{ch}^{h},W_{ch}^{z},W_{ch}^{r}∈R^{n×T} are weights.

In another aspect, the hidden state s is computed by the relation:

sₜ=oₜ∘tanh(Cₜ)

Cₜ=fₜ∘Cᵢ₋₁+iₜ∘tanh(W_{Ch}sᵢ₋₁+W_{Cy}e(yᵢ)+Ceᵢ)

fₜ=σ(W_{fh}sₜ₋₁+W_{fy}e(yᵢ)+C_{f}cᵢ)

iₜ=σ(Wᵢₕsₜ₋₁+W_{iy}e(yᵢ)+Cᵢcᵢ)

oₜ=σ(Wₒₕsₜ₋₁+W_{oy}e(yᵢ)+Cₒcᵢ)

Where C,C_{f},Cᵢ,Cₒ∈ [symbol] ^{h×2n},W_{Ch},W_{fh},Wᵢₕ,Wₒₕ∈ [symbol] ^{n×n} W_{Cy},W_{fy},W_{iy},W_{oy}∈ [symbol] ^{n×m} are weights.

In another aspect, the initial hidden state s₀ is computed by the relation:

s₀=tanh(Wₛh_{T}_{ₓ}),

where Wₛ∈ [symbol] ^{n×n}.

In another aspect, the context vector cᵢ is recomputed at each step by an alignment model having the relation:

$${c}_{i} = {\sum }_{j = 1}^{{T}_{s}} {α}_{ij} {h}_{j}$$

$$where$$

$${α}_{ij} = \frac{exp ( {e}_{ij} )}{{\sum }_{k = 1}^{{T}_{x}} exp ( {e}_{ik} )}$$

$${e}_{ij} = {v}_{a}^{T} tanh ( {W}_{a} {s}_{i - 1} + {U}_{a} {h}_{j} )$$

, and hⱼ is the j-th annotation in the source sentence, vₐ∈ [symbol] ^{n′},Wₐ∈ [symbol] ^{n′×n} and Uₐ∈ [symbol] n′×2n are weight matrices.

In another aspect, the probability of a target word yᵢ is defined using at least the decoder state sᵢ₋₁, the context cᵢ, and the last generated word yᵢ₋₁.

In another aspect, the probability of the target word yᵢ is defined using the relation:

p(yᵢ∈sᵢ,yᵢ₋₁,cᵢ|)∝exp(yᵢ^{T}Wₒtᵢ)

, where

tᵢ−[max{ [symbol] _{,2j-1}, [symbol] _{,2j}}]_{j=1, . . . , l}^{T}

and [symbol] ₖ is the k-th element of a vector [symbol] which is computed by

[symbol]

=Uₒsᵢ₋₁+VₒEyᵢ₋₁+Cₒcᵢ

In another aspect, a performance score of derived based at least on an evaluation of the response string includes a perplexity score.

In another aspect, the training set used by the CNN includes collected question-answer pairs extracted from external commercial websites.

In another aspect, there is provided a computer-implemented method for generating a response string based at least on a received inquiry string using a recurrent neural network (RNN) encoder-decoder architecture to improve a relevancy of the generated response string by adapting the generated response based on an identified probabilistic latent conversation domain, the method comprising: providing a first RNN configured to receive the inquiry string as a sequence of vectors x and to encode a sequence of symbols into a fixed length vector representation, vector c; providing a contextual neural network (CNN) for inferring topic distribution from a training set having a plurality of training questions and a plurality of training labels, the CNN configured to extract word features, compute syntactic features and infer semantic representation based on interconnections derived from the training set to generate a fixed length topic vector representation of a probability distribution in a topic space, the topic space inferred from a concatenated utterance of historical conversation; and providing a second RNN used as a RNN contextual decoder for estimating a conditional probability distribution of a plurality of responses, the second RNN configured to: receive the vector c and the fixed length topic vector representation of the probability distribution in a topic space; apply a layered gated-feedback mechanism arranged in a context-attention architecture to recursively apply a transition function to one or more hidden states for each symbol of the vector c; and estimating a conditional probability of the received inquiry string; and generating the response string based at least on the estimated conditional probability.

In another aspect, the CNN is an encoder including at least a convolutional layer with multiple filters, a K-max pooling layer, a convolutional layer capturing sequential features, a max-over-time pooling layer, and a fully connected layer.

In another aspect, the context-attention architecture provides a gated layer where a gated hidden unit is applied having the relation:

\ddot{h}ₜ=(1−zₜ)∘hₜ+zₜ∘\tilde{h}ₜ

where,

\tilde{h}ᵢ=tanh(Wₕ[rₜ∘hₜ]+W_{ch}^{h}cₕ)

zₜ=σ(W_{z}sₜ+W_{ch}^{z}cₕ)

rₜ=σ(Wᵣsₜ+W_{ch}^{r}cₕ), and

Wₕ,W_{z},Wᵣ∈ [symbol] ^{n×n} and W_{ch}^{h},W_{ch}^{z},W_{ch}^{r}∈R^{n×T} are weights.

In another aspect, the hidden state s is computed by the relation:

sₜ=oₜ∘tanh(Cₜ)

Cₜ=fₜ∘Cᵢ₋₁+iₜ∘tanh(W_{Ch}sᵢ₋₁+W_{Cy}e(yᵢ)+Ceᵢ)

fₜ=σ(W_{fh}sₜ₋₁+W_{fy}e(yₜ)+C_{f}cᵢ)

iₜ=σ(Wₜₕsₜ₋₁+W_{iy}e(yₜ)+Cᵢcᵢ)

oₜ=σ(Wₒₕsₜ₋₁+W_{oy}e(yₜ)+Cₒcᵢ)

where C,C_{f},Cᵢ,Cₒ∈ [symbol] ^{n×2n},W_{ch},W_{fh},Wᵢₕ,Wₒₕ∈ [symbol] ^{n×n} and W_{Cy},W_{fy},W_{iy},W_{oy}∈ [symbol] ^{n×m} are weights.

In another aspect, the initial hidden state s₀ is computed by the relation:

s₀=tanh(Wₛh_{T}_{ₓ}),

Wₓ∈ [symbol] ^{n×n}.

In another aspect, the context vector cᵢ is recomputed at each step by an alignment model having the relation:

$${c}_{i} = {\sum }_{j = 1}^{{T}_{s}} {α}_{ij} {h}_{j}$$

$$where$$

$${α}_{ij} = \frac{exp ( {e}_{ij} )}{{\sum }_{k = 1}^{{T}_{x}} exp ( {e}_{ik} )}$$

$${e}_{ij} = {v}_{a}^{T} tanh ( {W}_{a} {s}_{i - 1} + {U}_{a} {h}_{j} )$$

, and hⱼ is the j-th annotation in the source sentence. vₐ∈ [symbol] ^{n′},Wₐ∈ [symbol] ^{n′×n} and Uₐ∈ [symbol] n′×2n are weight matrices.

In another aspect, the probability of a target word yᵢ is defined using at least the decoder state sᵢ₋₁, the context cᵢ, and the last generated word yᵢ₋₁.

In another aspect, the probability of the target word yᵢ is defined using the relation:

p(yᵢ|sᵢ,yᵢ₋₁,cᵢ|)∝exp(yᵢ^{T}Wₒtᵢ)

, where

tᵢ=[max{ [symbol] ₂ⱼ₋₁ [symbol] ₂ⱼ}]_{j=1, . . . , l}^{T}

and [symbol] _{,k} is the k-th element of a vector [symbol] which is computed by

[symbol]

=Uₒsᵢ₋₁+VₒEyᵢ₋₁+Cₒcᵢ

In another aspect, a performance score of derived based at least on an evaluation of the response string includes a perplexity score.

In another aspect, there is provided a non-transitory computer readable medium storing machine-readable instructions which when executed by a processor, cause the processor to perform a method for generating a response string based at least on a received inquiry string using a recurrent neural network (RNN) encoder-decoder architecture to improve a relevancy of the generated response string by adapting the generated response based on an identified probabilistic latent conversation domain, the method comprising: providing a first RNN configured to receive the inquiry string as a sequence of vectors x and to encode a sequence of symbols into a fixed length vector representation, vector c; providing a contextual neural network (CNN) for inferring topic distribution from a training set having a plurality of training questions and a plurality of training labels, the CNN configured to extract word features, compute syntactic features and infer semantic representation based on interconnections derived from the training set to generate a fixed length topic vector representation of a probability distribution in a topic space, the topic space inferred from a concatenated utterance of historical conversation; and providing a second RNN used as a RNN contextual decoder for estimating a conditional probability distribution of a plurality of responses, the second RNN configured to: receive the vector c and the fixed length topic vector representation of the probability distribution in a topic space; apply a layered gated-feedback mechanism arranged in a context-attention architecture to recursively apply a transition function to one or more hidden states for each symbol of the vector c; and estimating a conditional probability of the received inquiry string; and generating the response string based at least on the estimated conditional probability.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a view of an example of an approach relating to a seq2seq model.

FIG. 2 is a block schematic depicting an example context-LSTM architecture, according to some embodiments.

FIG. 3 is an illustration depicting an example structure of a Contextual CNN encoder according to some embodiments.

FIG. 4 is a sample architecture of a context-in architecture, according to some embodiments.

FIG. 5 is a sample architecture of a context-IO architecture, according to some embodiments.

FIG. 6A is a sample architecture of a context-attention architecture, according to some embodiments.

FIG. 6B is a sample block schematic of an artificial neural network architecture, according to some embodiments.

FIG. 6C is an illustration of weighting bars, according to some embodiments.

FIG. 7 is an example computer architecture, according to some embodiments.

FIG. 8 is an example method, according to some embodiments.

### DETAILED DESCRIPTION

Natural language conversation has been a relevant topic in the field of natural language processing. In different practical scenarios, conversations are reduced to some traditional NLP tasks, e.g., question-answering, information retrieval and dialogue management. Recently, neural network-based generative models have been applied to generate responses conversationally, since these models capture deeper semantic and contextual relevancy.

Computer-based conversations (one sided or both sides) encounter difficulty with establishing relevance with responses. Accordingly, conventional neural conversational approaches typically produce generic or safe responses in different contexts, e.g., reply “Of course” to narrative statements or “I don't know” to questions.

While these generic or safe responses may be technically correct responses to questions, they do not offer much by way of relevance. Such generic responses may provide little value, for example, in situations where computer-implemented solutions are used to generate responses to inquiries (e.g., inquiries by humans). For example, if a human submits an inquiry string to a computer-based conversation device, the human would find a relevant response more useful than a simple “I don't know”-type generic response.

However, establishing relevance in the absence of direct human intervention is a technically difficult task given that computers do not have an appreciation for various nuances and intricacies inherent in human processing of language.

In some embodiments, systems, methods, devices, and computer-readable media are described that are directed to providing improved computer-based conversations implemented using specific steps and processes implemented on processors, computer-readable media, and computer memory. The embodied systems operate free of human interaction and specific approaches are provided to generate responses with increased relevance despite, for example, limited computing resources or available libraries for analysis.

Specific neural network topologies and adaptations are provided that have specific improvements. In particular, the present embodiments utilize a specially configured contextual neural network (CNN) that is adapted for use with one or more recurrent neural networks (RNNs) to improve the relevancy of computationally generated responses to various input strings (queries). For example, rather than the computing system providing a generic or safe response, a more relevant response may be determined, despite the absence of human interference (e.g., the contextual neural network aids in promoting relevancy despite not having an actual understanding of semantics).

Neural networks include computer systems that utilize sophisticated computational approaches where a number of neural units are provided that loosely model how a human brain solves a problem, for example, using clusters of connected computing models. The interconnections can be used, for example, to determine how information is propagated through the neural network, including when certain features should be carried on or eventually removed. For example, neural networks can be configured such that a “long short term memory” (LSTM) can be provided whereby features of human memory are computationally reproduced through a series of configured gates (e.g., reset gates, update gates). The gates may be configured to apply various weightings and determinations that modify how and when information is effectively transformed, propagated, or removed (e.g., through transfer functions defined between nodes). The transfer functions may be implemented, for example, by way of configured “hidden” layers that operate to transform received inputs at a node to generate outputs for that node.

As provided in the computer conversation systems developed and tested by Applicant, neural networks are particularly helpful in relation to complex pattern recognition tasks whereby a corpus of existing data is available for the neural network to utilize for learning. The relationships and interactions provided within the neural network are designed to be tuned over time, for example, in response to supervised (e.g., using labelled training data), unsupervised learning methods (e.g., cost reduction/outcome optimization using unlabelled data), or semi-supervised learning methods (e.g., some but not all data is labelled), among others. Neural networks are capable of generating estimated solutions to complex and diverse problems, including, as described below, computer-based generation of conversational responses.

Neural networks are implemented using computational approaches, including the use of specialized computing components, such as computer processors, field programmable gate arrays (FPGAs), electronic logic gates/integrated circuitry (e.g., transistor-based series of NAND gates), among others. Practical implementation details to consider when implementing neural networks include significant processing and storage resources that need to be utilized, having regard to finite and practical considerations of processing time, available resources (e.g., power available to mobile environments or supercomputers), space constraints (e.g., miniaturization), generated heat output, etc.

Applicants have developed computing models of different embodiments of the contextual neural network implementation, namely, the Context-In implementation, the Context-IO implementation, and the Context-Attention implementation. Each of the implementations will be described in the disclosure below, describing the physical components and structures underlying the implementations which, in concert, provide the improved computational conversational system.

In particular, the Context-Attention implementation was found to have the most improved performance relative to the models described herein. An improved architecture was found wherein computing devices and components are specially configured and interoperate with one another in concert to provide the improved result.

The embodiments described herein are directed to computational approaches to approximating appropriate responses to human language questions. Understanding that machines do not have the ability to contextualize or understand the semantics and nuances underlying human language, Applicants have applied computational processes that seek to improve the relevancy of computer generated responses.

Wth the help of user-generated contents such as Twitter™ and cQA websites, available conversational corpus has become good resources to be utilized as large-scaled training data. Following this strategy, Applicants attempted to solve more challenging tasks, such as dynamic contexts, discourse structures with attention and intention, and response diversity by maximizing mutual information.

The evaluation of conversations, i.e., to judge if a conversation is “good”, lacks of good measurement metrics. Ideally, a good conversation should be not only coherent, but also informative. However, this evaluation is difficult for non-humans as there are myriad technical challenges associated with pattern and context recognition.

Prior approaches, described herein, have been somewhat successful at obtaining coherent responses, but these computer-generated responses have lacked a level of context in providing informative responses.

Shang proposed four criteria to judge the appropriateness of responses: Coherent, topically relevant, context-independent and non-repetitive. However, this task focuses on single-round responses; it does not consider the contexts thus is different from the objective of some of the claimed embodiments. Moreover, it is difficult to quantify these criteria automatically with computational algorithms. In the field of machine translation, the bilingual evaluation understudy (BLEU) algorithm has been traditionally used to evaluate the quality of translated texts. This measurement captures the language model from the word level, and achieves a high correlation with human judgements. However, in recent years, the perplexity measurement shows a better performance on judging languages in open domains. It is used to evaluate neural network-based language learning tasks.

Note that the scale of perplexity scores of tasks in different languages differ greatly. For example, an RNN encoder-decoder model for English-to-French translation has a perplexity score of 45.8, while an attention-free German to English translation model has a score of 12.5, and 8.3 in reverse. Moreover, for English to French, the perplexity score could be even lower at 5.8.

This is natural since the complexity of languages differ from each other. Nevertheless, the relative differences of models on the same task could still reflect the improvement. Accordingly, the perplexity of languages may impact the ability for computer-based conversation engines to provide relevant responses. In some embodiments described herein, specific computational approaches are proposed to address some of the technical problems encountered herein.

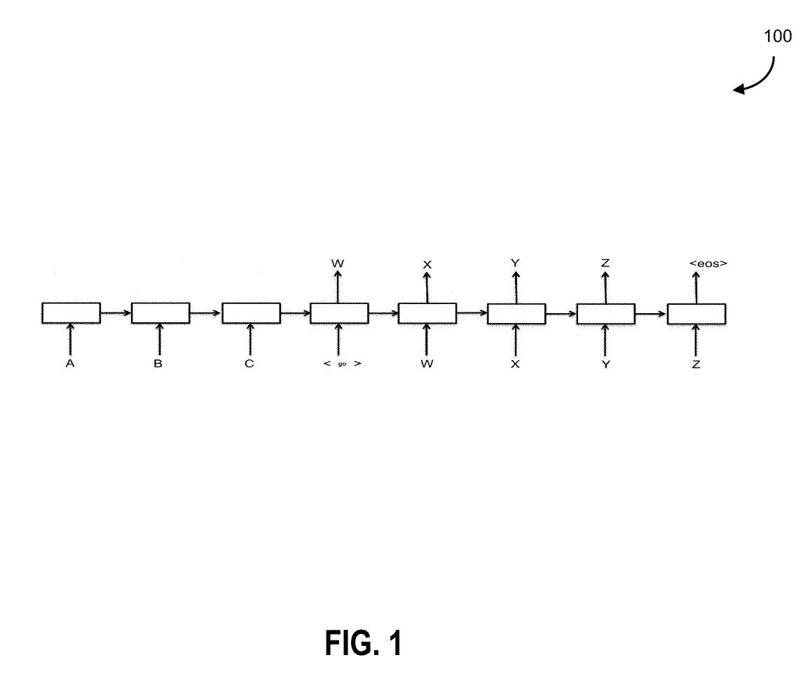

For example, a study has proved the effectiveness of an seq2seq recurrent model over the traditional n-gram based methods: the study shows the perplexity scores of 8 and 17 for the seq2seq model, compared with 18 and 28 for the n-gram model, on a close-domain of IT helpdesk troubleshooting and an open domain of movie conversations, respectively. A illustrative seq2seq model 100 is shown in FIG. 1.

In Applicant's experiments of the Chinese language, the perplexity scores tend to be higher; but similarly, Applicants could demonstrate the effectiveness of a contextual model by lower perplexity scores. Additional memory mechanisms have been introduced to standard sequence-to-sequence (seq2seq) models, so that context can be considered while generating sentences. Three seq2seq models, which memorize a fixed-length contextual vector from hidden input, hidden input/output and a gated contextual attention structure respectively, have been trained and tested on a dataset of labeled question-answering pairs in Chinese.

Some embodiments utilizing contextual attention were found to outperform others including the state-of-the-art seq2seq models, on a perplexity test.

In some embodiments, the novel contextual model generates improved robust and diverse responses, and is able to carry out conversations on a wide range of topics appropriately.

A conversational dialogue model generates an appropriate response based on contextual information (e.g., circumstance, location, time, chatting history) and a conversational stimulus (i.e., utterance here). Many studies have attempted to create dialogue models by learning from large datasets, e.g., Twitter or movie subtitles. Data-driven approaches of statistical machine translation and neural sequence-to-sequence (seq2seq) generation have been adapted to generate conversational responses. Some challenges that arise with these approaches include context-sensitivity, scalability and robustness.

The conversational system described herein has been practically implemented for use with a consumer-level physical product. The consumer-level physical product is used in conjunction with a cloud service. When a user converses with the product, the product was configured to transfer each speech to text with a ASR system, and send each textual message to a product-based conversational system through the Internet. The cloud system memorizes historical messages in a session from each product.

Given historical messages and the current message, the cloud system was able to generate a possible textual response and send it back to the product, which then synthesized speech from the textual message with another text-to-speech tool and played the message back to the product's user.

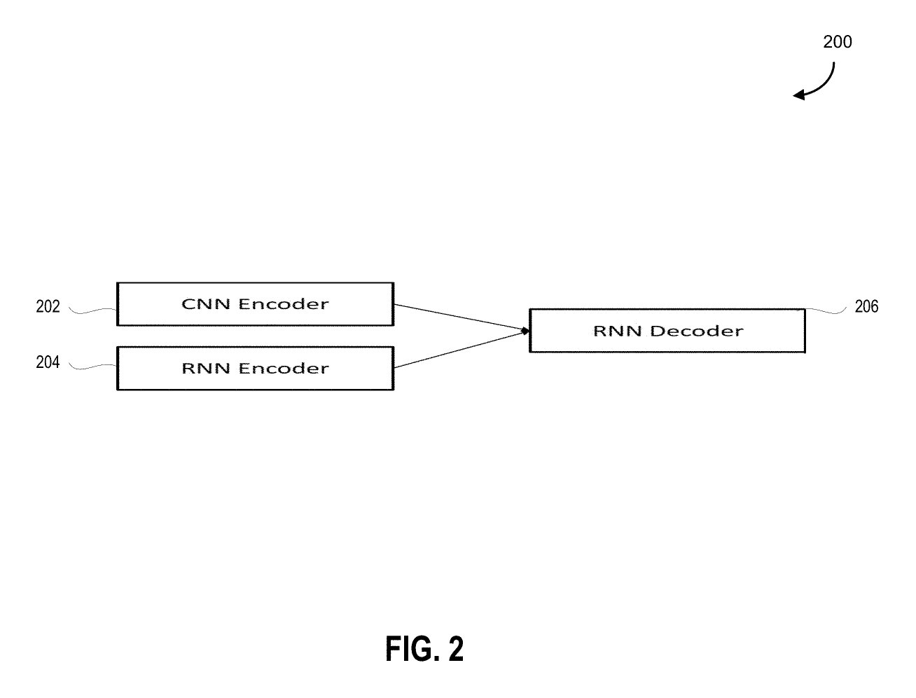

The use of two recurrent neural networks (RNNs) to map sequences with different lengths is provided in the approach shown in the block schematic of FIG. 2.

An end-to-end machine translation model from English to French without any sophisticated feature engineering is shown, in which a model is used to encode source sentences into fixed-length vectors, and another to generate target sentences according to the vectors.

An attention mechanism on a bidirectional RNN-encoder may be used, and state-of-the-art machine translation results may be obtained. An earlier approach may include training an end-to-end conversational system using the same vanilla seq2seq model. It generates related responses, but they tend to be generic responses, e.g., “Of course” or “I don't know”.

There are other approaches to avoid such problems that gain improvements by either encoding previous utterance as additional inputs or optimizing on a mutual-information function instead of cross-entropy. However, these approaches do not specify particular memory mechanism to memorize context and do not come to any conclusion about computing efficiency of contextual information.

Systems, methods, and computer readable media are described that provide, in some embodiments, an end-to-end approach to overcome and/or avoid such problems in neural generative models. Embodiments of methods, systems, and apparatus are described through reference to the drawings.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

FIG. 2 is an architecture model 200 illustrating an example architecture for providing a contextual seq2seq model. As described in this application, an additional CNN-encoder is advantageously utilized that is adapted to computationally “memorize” useful information from the context, such that the CNN-encoder-enabled system achieves improved performance of sentence generation (e.g., improved relevancy).

As depicted in FIG. 2, Applicants, in various embodiments, have designed a computational conversational approach that identifies the change of latent topics. Simulated human conversation using some embodiments of architectures described by Applicants is smooth, because the architecture is able to computationally identify latent topics of chatting in different environments and thus provide adaptive responses.

Applicants have found that such additional contextual information is helpful for seq2seq model to generate domain-adaptive responses and is effective on learning long-span dependencies. As provided in some embodiments, a neural network is trained on a community question-answering (cQA) dataset first, and then is trained continuously on another conversation dataset.

A convolutional neural network (CNN) 202 is used to extract text features and to infer latent topics of utterance.

A long short-term memory (LSTM) architecture is applied to process the source sentence, and another contextual LSTM is used to process the target sentence. The CNN-encoder 202 and the RNN-encoder 204 are both connected to the RNN-decoder 206.

The encoders 202, 204 and the decoder 206 together estimate a conditional probability distribution of output sentences, given input sentences and contextual labels.

Some potential benefits include, and are not limited to: (1) improved conversational response generation by inventing the contextual training; (2) an conversation learning approach that is an end-to-end approach without feature engineering nor external knowledge; and (3) the providing of three different mechanisms that memorize contextual information and evaluate them.

### CNN Contextual Encoder 202

Instead of depending on an external topic, the architecture utilizes a CNN topic inferencer to learn topic distribution from questions and their labels.

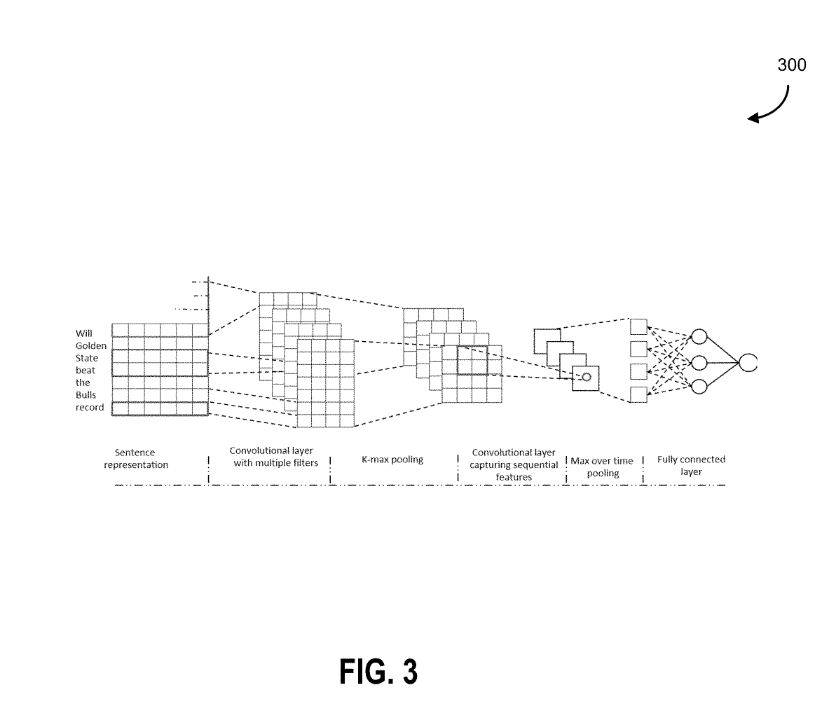

The architecture builds the CNN 202 based on a sentence classifier. As shown in FIG. 3, the architecture provides a dynamic k-max pooling layer and chooses different hyper-parameters that fit the Chinese character-level learning. As illustrated in FIG. 3, the architecture of the CNN may receive a sentence representation, which then applies approaches to generate a fully connected layer, for example, by applying a convolutional layer with multiple filters, K-max pooling, a convolutional layer capturing sequential features, max over time pooling, etc.

The widths of first-layer filters are fixed to the embedding size. Meanwhile, the heights are set from 1 to 4, as over 99% of Chinese words consist of no more than four characters in the cQA dataset. The CNN 202 firstly extracts basic word features, then computes syntactic features and infers semantic representation at the succeeding layers.

Instead of producing classification results, the CNN 202 generates a fixed-sized vector representing a probability distribution in topic space. The architecture is configured to infer the topic vector from a concatenated utterance of historical conversation in the following equation:

c_{τ}=g(X_{τ}□X_{τ-1}□ . . . )

where c_{τ} and X_{τ} indicates topic representation and character sequence of utterance at round τ. In this setting, it is flexible to compute various length of context but does not increase gradient computation, in comparison to a RNN Contextual Encoder.

### RNN Contextual Decoder 204

A RNN 204 determines output yₜ from an input xₜ in sequence x₁;x₂; : : : ; x_{T} at time t as following:

hₜ=f(Wₕₓxₜ+Wₕₕhₜ₋₁)

yₜ=W_{yh}hₜ

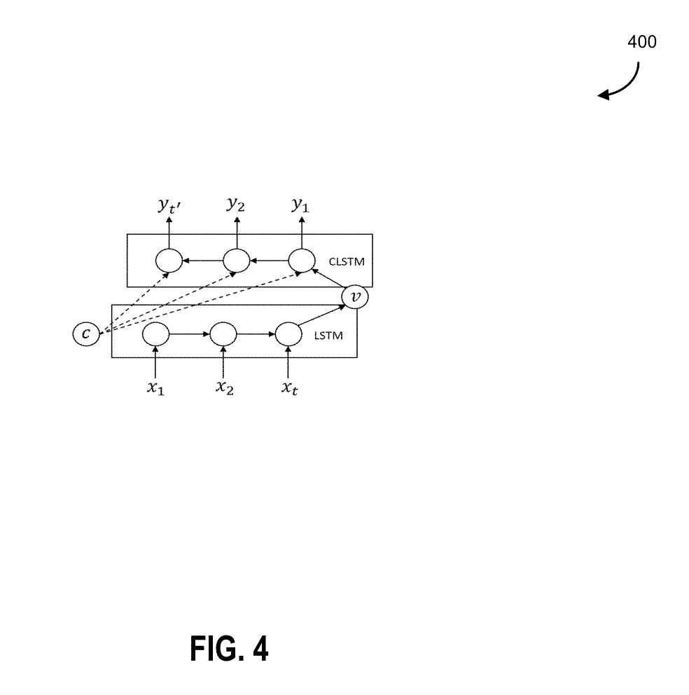

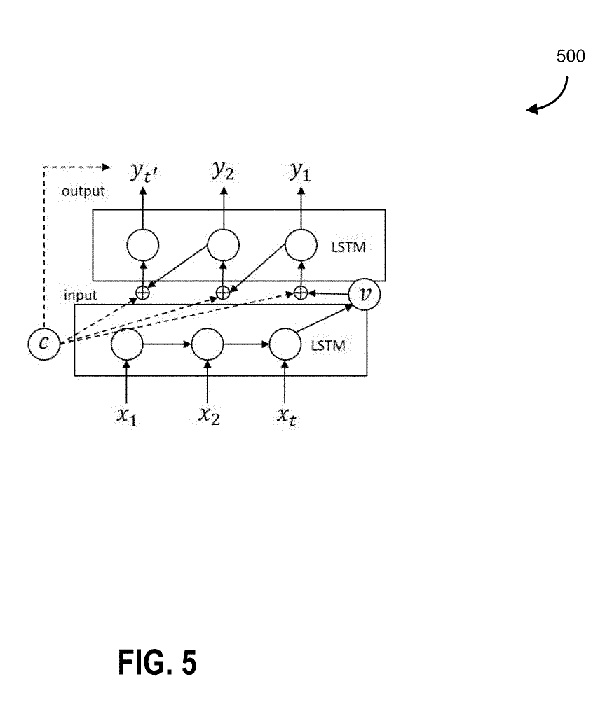

The approach is shown in the contextual models illustrated at FIGS. 4 and 5.

The architecture applies the encoder-decoder seq2seq on conversation learning. The model estimates the conditional probability p(y₁;:::; y_{T′}|x₁;:::; x_{T}) of the source sequence (x₁;:::; x_{T}) and the target sequence (y₁;:::; y_{T}¹). To determine this probability, the LSTM-encoder computationally determines the fixed-sized representation v from the source, and then the decoder computes the target sequence by:

$$p ( {y}_{1} , … , {y}_{{T}_{y}} \vert {x}_{1} , … , {x}_{{T}_{x}} ) = {\prod }_{t = 1}^{{T}_{y}} p ( {y}_{t} \vert v , {y}_{1} , … , \vert {y}_{t - 1} )$$

As described above, another CNN-encoder is added to the seq2seq architecture. The RNN decoder depends not only on an RNN-encoder but also on the CNN-encoder. The CNN produces a contextual vector c from the question. The contextual seq2seq model of some embodiments estimates a slightly different conditional probability:

$$p ( {y}_{1} , … , {y}_{{T}_{y}} \vert {x}_{1} , … , {x}_{{T}_{x}} ) = {\prod }_{t = 1}^{{T}_{y}} p ( {y}_{t} \vert v , {c}_{h} , {y}_{1} , … , {y}_{t - 1} )$$

Three types of contextual encoder-decoder models with different structures may be utilized to memorize the contextual information. The models share a same structured CNN-encoder 202 and RNN-encoder 204, but have different contextual RNN decoders 206.

### Context-In Architecture

A first architecture is configured to let the LSTM memorize the context with language together.

The LSTM uses a forget gate fₜ and an input gate iₜ to update its memory. Wth the contextual vectors, a contextual-LSTM (CLSTM) is able to compute the gates with contexts, by:

fₜ=σ(W_{f}[hₜ₋₁,xₜ]+b_{f}+W_{cx}c)

iₜ=σ(Wᵢ[hₜ₋₁,xₜ]+bᵢ+W_{cx}c)

Cₜ=fₜ*Cₜ₋₁+iₜ*tanh(W_{C}[hₜ₋₁,x]|b_{C}|W_{cx}c)

oₜ=σ(W₀[hₜ₋₁,xₜ]+bₒ+W_{cx}c)

hₜ=oₜ*tanh(cₜ)

where c is the contextual vector and W_{cx} is the weight of the vector.

The context-In architecture, in some embodiments, is provided as shown in FIG. 4.

### Context-IO Architecture

The decoder network of FIG. 5 observes context both at the hidden input layer and the output layer. Instead of improving a basic RNN language model, some embodiments of the architecture apply such settings in the LSTM decoder of a standard seq2seq model to build the Context-IO architecture (as depicted in FIG. 5):

s(t)=lstm(Wₓxₜ₋₁+W_{cx}c·Cₜ₋₁)

y(t)=softmax(W_{y}yₜ₋₁+W′_{cx}c)

### Context-Attention Architecture

The previous architectures apply the context computation intuitively. A potentially improved strategy is to involve contextual vectors in attention computation.

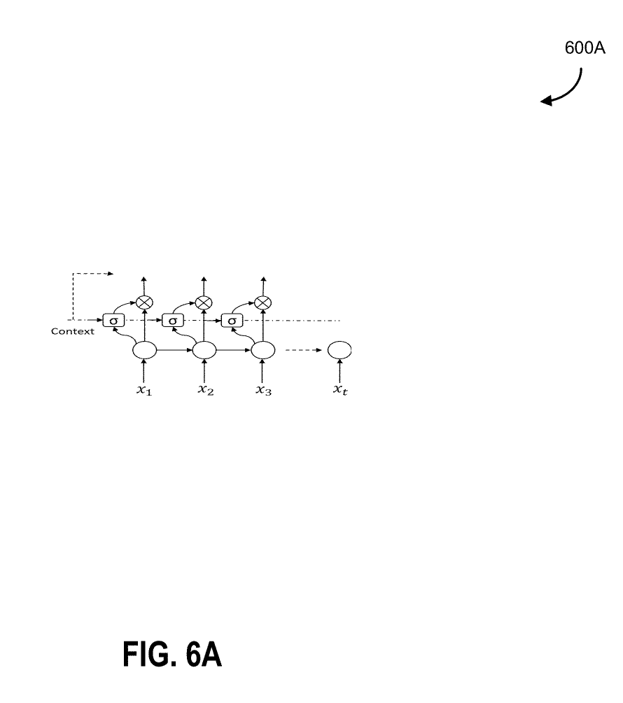

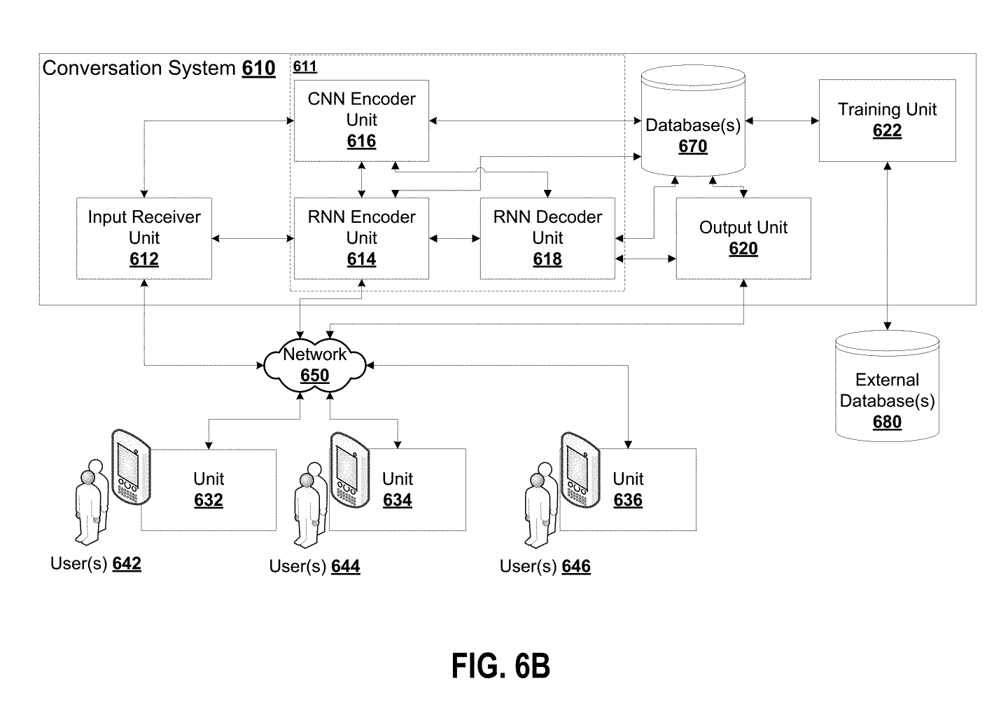

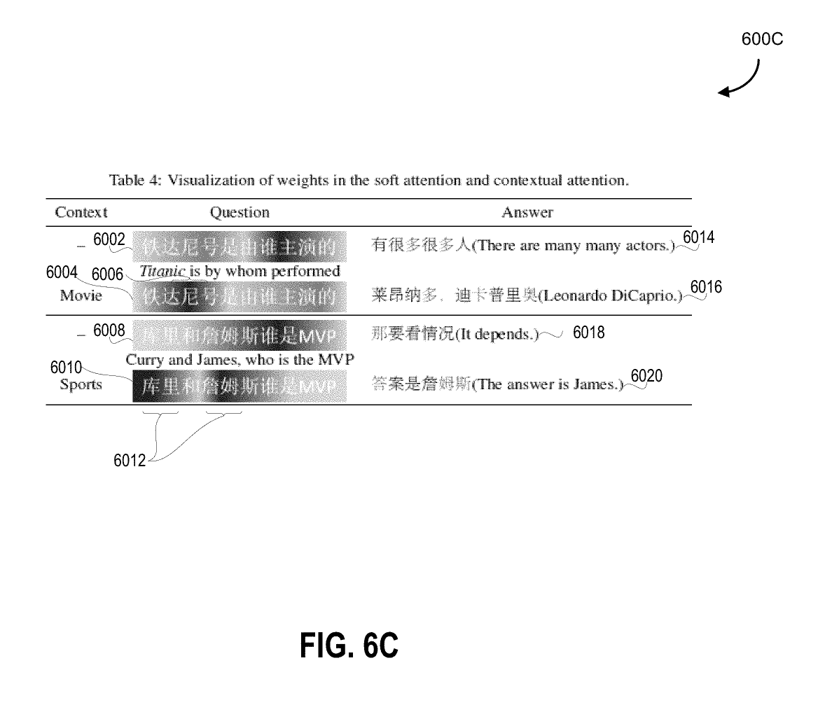

The Context-Attention architecture applies a novel contextual attention structure shown, as an example, in FIG. 6A. It uses gates to update the attention inputs. Each gate is computed by the source output hₜ and the contextual vector c by:

gₜ=σ(Wₜ^{c}·c+Wₜ^{h}·hₜ+b_{c})

The updated source outputs are sent to a one-layer CNN to compute the attention vector. The attention vector is computed at each target input of its RNN-decoder.

An advanced approach is to involve contextual vectors in the attention computation.

A gated layer which is similar to a gated hidden unit is generated using the relation:

\ddot{h}ₜ=(1−zₜ)∘hₜ+zₜ∘\tilde{h}ₜ, where

\tilde{h}ₜ=tanh(Wₕ[rₜ∘hₜ]+W_{ch}^{h}cₕ)

zₜ=σ(W_{z}sₜ+W_{ch}^{z}cₕ)

rₜ=σ(Wᵣsₜ+W_{ch}^{r}cₕ)

are weights. m and n are the word embedding dimensionality and the number of hidden units, respectively.

The hidden state sᵢ of the decoder given the annotations h₀, . . . , h_{Tx} from the encoder is computed by:

sₜ=oₜ∘tanh(Cₜ)

Cₜ=fₜ∘Cₜ₋₁+iₜ∘tanh(W_{Ch}sₜ₋₁+W_{Cy}e(yₜ)+Ccᵢ)

fᵢ=σ(W_{fh}sₜ₋₁+W_{fy}e(yₜ)+C_{f}cᵢ)

iᵢ=σ(Wᵢₕsₜ₋₁+W_{iy}e(yₜ)+Cᵢcᵢ)

where

C,C_{f},Cᵢ,Cₒ∈ [symbol] ^{n×2n}, W_{Ch},W_{fh},Wᵢₕ,Wₒₕ∈ [symbol] ^{n×n} and W_{Cy},W_{fy},W_{iy},W_{oy}∈ [symbol] ^{n×m}

are weights, e(⋅) is the the same word embedding lookup function. The initial hidden state s₀ is computed by s₀=tanh(Wₛh_{Tx}), where Wₛ∈ [symbol] ^{n×n}.

The context vector cᵢ is recomputed at each step by the alignment model:

$${c}_{i} = {\sum }_{j = 1}^{{T}_{s}} {α}_{ij} {h}_{j}$$

$$where$$

$${α}_{ij} = \frac{exp ( {e}_{ij} )}{{\sum }_{k = 1}^{{T}_{x}} exp ( {e}_{ik} )}$$

$${e}_{ij} = {v}_{a}^{T} tanh ( {W}_{a} {s}_{i - 1} + {U}_{a} {h}_{j} )$$

, and hj is the j-th annotation in the source sentence.

Vₐ|∈ [symbol] ^{n′}, Wₐ∈ [symbol] ^{n′×n} and Uₐ∈ [symbol] n′×2n are weight matrices. Note that the model becomes RNN Encoder-Decoder, if the approach fixes cᵢ to h_{Tx}. With the decoder state sᵢ₋₁, the context cᵢ and the last generated word yᵢ₋₁, the probability of a target word yᵢ is defined as p(yᵢ|sᵢ,yᵢ₋₁,cᵢ)∝exp(yᵢ^{T}Wₒtᵢ), where tᵢ=[max{ [symbol] _{,2j-1}, [symbol] _{,2j}}]_{j-1, . . . , l}^{T}, and [symbol] ,k is the k-th element of a vector [symbol] which is computed by \tilde{t}ᵢ=Uₒsᵢ₋₁+VₒEyᵢ₋₁+Cₒcᵢ.

Wₒ∈ [symbol] ^{K}^{_{y}}^{×l}, Uₒ∈ [symbol] ^{2l×n}, Vₒ∈ [symbol] ^{2l×m} and Cₒ∈ [symbol] ^{2l×2n} are weight matrices. This can be understood as having a deep output with a single maxout hidden layer.

FIG. 6B is an example block schematic of a machine conversation system 210, according to some embodiments. The conversation system 210 is utilized in relation to a computing system configured for approximating human conversation.

The computing system includes various processors and memory, and is configured to provide one or more data structures for storing and/or processing electronic information. The data structures, for example, many include electronic representations of weighted graphs that are used to store state and other information.

The conversation system 210 implements an artificial neural network-based system 211 wherein computing components, operating in concert, provide a series of computer-implemented neural units. These neural units, as described throughout this application, are interconnected components configured for conducting processing steps that, in some embodiments, are iterative and/or recursive. In some embodiments, some neural units are configured to process electronic information based on states of past or future information (e.g., in various feedback loops).

Artificial neural units may be organized into analysis layers, and may be configured to minimize a measure of error (e.g., using optimization approaches in relation to determined errors). Neural units exhibit dynamic behavior as inputs are received and considered by the conversation system 210. For example, the weights of connections in the neural networks may be modified as information flows through the conversation system 210.

Neural units are specially configured to provide particular characteristics and behavior as a corpus of inputs (e.g., training and non-training data) is provided. Depending on the particular technical configuration, the neural units may exhibit markedly different dynamic behavior. Different mechanisms (e.g., gating mechanisms) are utilized in combination with feedback such that neural units, in some embodiments, are configured to maintain information for periods of time and protect gradients inside a neural unit from harmful changes over time (e.g., during training).

Applicants have designed several computer conversation systems that, as described below, have exhibited improved outcomes in relation to contextual accuracy in relation to machine-generating conversation elements absent human intervention, and accordingly, specific architectures are proposed that provide accuracy and contextual improvements over nave conversation systems. These computer conversation systems have been tested against real-world data sets, training data sets, and in practical implementations whereby real-time inputs were processed for automatically generating responses free of human intervention.

The system may receive inputs from the input receiver unit 612 (e.g., as text/voice inputs). In the event that voice inputs are received at the input receiver unit 612, the input receiver unit 612 may be configured to first transform the voice inputs to extract text inputs (e.g., including a speech to text unit). The input receiver unit 612 may include, for example, an API to a speech to text unit, a text input receiver, a text input extractor, among others. In some embodiments, training data from training unit 622 may be input in bulk. Input receiver unit 612 may connect to various other systems, devices, and computing components through network 650. For example, inputs may be received through one or more computing devices 632, 634, 636 associated with users 642, 644, 646 whereby various inquiries are received that are awaiting computer generated responses (e.g., chatbot conversations).

Artificial neural network-based system 611 provides a recurrent neural network (RNN) encoder-decoder architecture to improve a relevancy of the generated response string by adapting the generated response based on an identified probabilistic latent conversation domain. In some embodiments, artificial neural network-based system 611 is a structured as a context-attention architecture as described in various embodiments.

The system includes a first RNN unit 614 configured to receive the inquiry string as a sequence of vectors x and to encode a sequence of symbols into a fixed length vector representation, vector c.

A contextual neural network (CNN) unit 616 is provided for inferring topic distribution from a training set having a plurality of training questions and a plurality of training labels, the CNN unit 616 configured to extract word features, compute syntactic features and infer semantic representation based on interconnections derived from the training set to generate a fixed length topic vector representation of a probability distribution in a topic space.

In some embodiments, the CNN unit 616 includes at least an encoder including at least a convolutional layer with multiple filters, a K-max pooling layer, a convolutional layer capturing sequential features, a max-over-time pooling layer, and a fully connected layer.

Gated layers can be utilized in relation to the context-attention architecture, and including, for example, a gated hidden unit provided that implements the context-attention architecture The topic space is inferred from a concatenated utterance of historical conversation.

A second RNN 618 used as a RNN contextual decoder for estimating a conditional probability distribution of a plurality of responses, the second RNN 618 configured to: receive the vector c and the fixed length topic vector representation of the probability distribution in a topic space; apply a layered gated-feedback mechanism arranged in a context-attention architecture to recursively apply a transition function to one or more hidden states for each symbol of the vector c; estimate a conditional probability of the received inquiry string and generate the response string based at least on the estimated conditional probability.

The response string is provided to the output unit 620, which may be utilized to generate one or more inputs based on a received response string or a plurality of response strings. In some embodiments, output unit 620 is adapted to transform the response string(s) into outputs that are readily consumed by a computing device of a user. For example, output unit 620 may include a text to voice encoder for controlling a speaker in generating sounds corresponding to the response string(s).

In some embodiments, the response string(s) are transformed for display on one or more graphical user interfaces, including, for example, chat screens, automated response generation mechanisms, webpages, mobile applications, among others.

The artificial neural network, rules, weightings, and data structures may be stored on data storage which may be database 670. Other data storage mechanisms are contemplated.

A training unit 622 is provided that is coupled to external databases 680, and the training unit 622 may be used to refine and train the artificial neural network system by way of obtaining a corpus of inputs and responses from various sources, such as the Internet, training databases, etc. The training corpus may be used to validate, instantiate, and/or otherwise prepare the artificial neural network. Different training data sets can be used for different contextual discussion topics (e.g., basketball, world news, history).

In some embodiments, different data structures may be used. In a practical implementation, Applicants have experimented with creating a dialogue system for kids under 12, which has a dialogue agent (dialogue management) distributing human language queries to multiple conversation systems. It has a topic classifier configured to block certain topics (e.g., Political, Adult), and a discriminator at the end of the to choose the best response according to semantic features, for example, based on processing conducted by a specific context-attention architecture as described above. In this example, a first conversation module may be utilized, then a dialogue agent, a second conversation module, and a discriminator, prior to the application of a contextual generation (e.g., using the context-attention architecture) to provide a suitable contextual response in relation to a topic classification.

### Experimental Results

### The Topic-Aware Dataset

In community Question-Answering (cQA) websites, users post questions under specific categories. After a question is posted, other users will then answer it, just as providing appropriate responses. Considering the question category as the context, these question-answer (QA) pairs can be used as good sources of topic-aware sentences and responses. A few examples are provided below in Table 1.

Applicants collected over 200 million QA pairs from two biggest commercial cQA websites in China: Baidu Zhidao™ and Sogou Wenwen™. In these websites, the categories are organized in a hierarchical structure; users may choose a category in any level.

To reduce the errors when a user choose a wrong category, Applicants manually select 40 categories according to three aspects: the popularity, overlapping with other categories, and ambiguity of the category definition. For example, the categories literature, music, movie, medical, and chatting are selected, but the categories amusement, dating, and neurology are not selected. Applicants have also merged the category trees from different websites before the selection.

Some of the questions do not have good answers for whatever reasons. Otherwise, at least one of the answers is marked as the best answer by human. This mark is a good indicator of the quality of questions and answers. Therefore, Applicants have selected QA pairs that have at least one best answer within the 40 categories, resulting in ten million in total. The test set contains another 2,000 QA pairs.

In some embodiments, Applicants found that normalization was helpful to provide an improved learning on human text. Accordingly, in some embodiments, a normalization step is provided first wherein for a particular string, the system replaced every punctuation but comma, period or question mark, and also filtered out text that only contains http links or phone numbers.

A neural network has been configured to learn robustness from consistent reasoning between questions and answers, and also to learn the topic representation of utterance from questions and labels.

TABLE 1
Samples of the cQA data.

| Category | Question-Answer Pair |
|---|---|
| Movie | Q: 2015 [symbol] [symbol] |
| | Are there any movies by Jackie Chan in 2015? |
| | A: [symbol] [symbol] [symbol] [symbol] [symbol] |
| | There are two of them: Dragon Blade and the |
| | other one Skiptrace from Hollywood. |
| Sports | Q: [symbol] [symbol] [symbol] |
| | Will LeBron James be in the NBA final next year? |
| | A: [symbol] [symbol] [symbol] |
| | It depends on the recovery of Love and Kyrie Irving. |
| Science | Q: [symbol] [symbol] |
| | Why is the sky blue? |
| | A: [symbol] [symbol] [symbol] [symbol] |
| | A clear cloudless sky appears to be blue, because the |
| | air molecules scatter blue light from the sun more |
| | than red light. |

### Conversational Dataset

A conversation dataset has been acquired from two popular forum websites: Baidu Tieba™ and douban™. Applicants collected around 100 million open-domain posts with comments. The data is cleaned and reorganized to a set of chatting sessions, in which each session contains multiple turns of conversation between two people(examples are listed in Table 2). The architectures are configured to learn basic conversation and context from such conversational dataset.

TABLE 2
Samples of the conversation data.

| Role | Utterance |
|---|---|
| Alice | [symbol] [symbol] [symbol] |
| | I really want a master of mathematics to lead me forward. |
| Bob | [symbol] [symbol] [symbol] |
| | They might be suffering from all kinds of examinations |
| Alice | [symbol] |
| | It is hard to say. |
| Alice | [symbol] |
| | There must be some geniuses. |
| Bob | [symbol] [symbol] |
| | But they have to work hard for their dreams too. |

### Experiment Settings and Results

The contextual architectures of some embodiments rely on a CNN-encoder, pre-trained on questions and their category labels. Given a utterance as the input, the CNN-encoder turns it into a topic vector of size 40. To prove its efficiency, cross validations of label prediction(classification) accuracy is tested on the Chinese dataset. The model of a prior approach provided by Kim produces 75.8% accuracy trained on the same dataset, by contrast, 77.9% is reported by the CNN of some embodiments.

In an experiment, the fixed-sized topic vectors is computed on previous utterance and current utterance. It is used as the contextual information in succeeding experiments. Two types of the encoder-decoder networks, two baseline models, and three contextual models are evaluated. The baseline models include models provided by Sutskever et al. (2014) and Bandanau et al. (2014), using the same settings in original papers.

They all have the same RNN-encoder which is implemented with a 3-layer LSTM, sized 1000. The dropout technique is applied in each LSTM cell and output layers. All these models are trained on the cQA dataset initially and then on the conversation dataset.

For contextual models, contextual vectors are computed by current questions when training on cQA dataset and computed by concatenated utterances of previous and current chats while training on the conversation dataset. An Adam approach for GPU accelerators is applied for all training. Table 3, below, show the various perplexities determined experimentally for different architectures/approaches.

TABLE 3
Perplexities of models on sentences of different lengths.

| | Short Sentences | Long Sentences |
|---|---|---|
| Models | (length <20) | (length >30) |
| Sutskever et al. (2014) | 10.50 | 33.46 |
| Bahdanau et al. (2014) | 9.10 | 28.12 |
| Context-In | 9.20 | 30.50 |
| Context-IO | 9.10 | 29.50 |
| Context-Attn | 8.75 | 26.00 |

In these experiments, the architectures of some embodiments are also configured to learn conversation on the character level. The performances are evaluated by perplexity. However, the perplexity differ greatly between short sentences and long sentences, hence the Applicant has divided them into two groups for a clearer comparison, as provided in Table 3.

Generally, shorter sentences generated by the models are better—with smaller perplexity—than longer sentences. It is most likely that the gradients are vanishing in long recursions, though LSTM is already applied.

From Table 3, it can be observed that the Context-Attention model achieves overall the best perplexity. It works surprisingly well for the conversation learning task, as the additional memory structure creates local connections from each source LSTM to each target LSTM.

The attention mechanism is an independent process from RNN, thus it reduces the long-span learning problem by establishing direct dependencies. Models with context settings achieve smaller perplexity scores than the vanilla LSTM model, since the additional memory of context is static. While decoding target sequences, improvements may be attained by further avoiding the gradient vanishing problem by feeding the additional information to decoder RNN at each time. This may be a potential contributing factor as to why combing attention and context in Context-Attn gains better performance.

However, perplexity only indicates how well a model predicts a target sequence. Low perplexity does not imply good quality of generating conversation or answering questions.

Therefore, Applicants apply beam search to sample the most likely sequences on the RNN-decoder. Based on human evaluations, Applicants found that the Context-Attention model performs better than other models and it is able to overcome the generic-generating problem. The following examples demonstrate the conversation quality of the Context-Attn model.

Chatting (Sports)

| | | |
|---|---|---|
| Human | [symbol] | Hi! |
| Machine | [symbol] | Hello, hello. |
| Human | [symbol] | Who are you? |
| Machine | [symbol] | I am myself. |
| Human | [symbol] [symbol] | Do you like sports? |
| Machine | [symbol] | Yes, I love fitness. |
| Human | [symbol] [symbol] | Where do you workout usually? |
| Machine | [symbol] | I'd like to go to Haosha Fitness. |
| Human | [symbol] [symbol] | I don't really like workout, it's too heavy. |
| | [symbol] | Do you like basketball? |
| Machine | [symbol] | I like basketball. |
| Human | [symbol] [symbol] [symbol] | Who do you think will win the final champion, Curry or James? |
| Machine | [symbol] | I believe James will win. |

Chatting (Movie)

| | | |
|---|---|---|
| Human | [symbol] | Many movies are released recently. |
| Machine | [symbol] | What movies? |
| Human | [symbol] | Inception is pretty impressive. |
| Machine | [symbol] | Of course, it is good. |
| Human | [symbol] | Which movie do you like best? |
| Machine | [symbol] | I love Legend of the White Snake. |
| Human | [symbol] | Who was in the movie? |
| Machine | [symbol] | Wallace Huo played. |
| Human | [symbol] [symbol] | Why could't Xu Xian and Bai Suzhen be together? |
| Machine | [symbol] | Because Xu Xian was a woman too. |
| Human | [symbol] [symbol] | OK, you win. |
| Machine | [symbol] | Haha! |

Question Answering

| | | |
|---|---|---|
| Human | [symbol] | Who is the president of the United States? |
| Machine | [symbol] | Obama. |
| Human | [symbol] | How many people live in China? |
| Machine | 14 [symbol] | About 1.4 billion. |
| Human | [symbol] | Where is the highest mountain in the world? |
| Machine | [symbol] | The peak of Mount Everest. |
| Human | [symbol] | Who invented the light bulb? |
| Machine | [symbol] | Edison invented the light bulb. |
| Human | [symbol] [symbol] | When did the industrial revolution take place in France? |
| Machine | [symbol] | It was during the Renaissance period. |
| Human | [symbol] | What is the Chinese national anthem? |
| Machine | [symbol] [symbol] | The national anthem is March of the Volunteers. |

These examples illustrate that the architecture generates reasonable responses with domain-specific vocabulary, while avoid safe but general answers to some extent.

Even for the task of question answering, the architecture provides the capability of providing (mostly) correct answers. The reason is that the contextual attention structure memorizes important (or frequent) information, which is usually the answer to the question.

In some cases (marked with * in the examples), the answers are incorrect. For example, Wallace Huo has played in neither movies nor TV series on the Legend of the White Snake; Xu Xian was actually a man (although in a TV show he was played by an actress); and the industrial revolution in France took place more than 300 years after the Renaissance. The results may be indicative that the memory itself works differently from a real question-answering mechanism.

To further demonstrate the efficiency of the contextual approaches of some embodiments, the weights in original soft attention and the contextual gated attention implementation are visualized in the illustration 600C of FIG. 6C. In FIG. 6C, bar graphs showing the visualization of weights in a soft attention and a contextual attention model are provided. The bar graphs are 6002, 6004, 6008, and 6010. 6002 is directed to a context-free weighting for a question related to movies (“Titanic is by whom performed”), 6004 is directed to show weighting where the context is determined to be “movie”, 6008 is directed to a context free weighting for a question related to sports (“Curry and James, who is the MVP”), and 6010 is directed to show weighting where the context is determined to be “sports”.

Darker colors represent larger value of weights. Sentences are translated to English literally to show the correspondence of words. 6006 and 6010 show that in the contextual gated attention implementation, additional weighting is used in relation to words that are relevant to the context (shown as 6006, “Titanic”, and shown as 6012, Curry and James). Responses 6014, 6016, 6018, and 6020 are provided. 6014 and 6018, while technically correct, safe answers, are not very informative. For automated chatting systems, these types of answers are not useful in providing information or providing for a smooth conversation flow.

On the other hand, 6016 and 6020 are generated based on the contextual attention model, and the system, using the neural networks, has identified improved contextual answers that may not always be correct but have a better chance of being informative by way of the improved contextual weighting that manipulates and/or transforms the generation process in an automated attempt to arrive at a more informative answer free of human intervention.

In operation, the Context-Attention architecture estimates a conditional probability distribution of responses given source sentences and context vectors. The additional gates in the contextual attention automatically determine which to augment and which to eliminate by computing contextual information. For example, the context-attention architecture may review the words of the received inquiry string as received, and based on the vector c, augment or eliminate words for review by, for example, modifying weightings accordingly based on the context of a particular word or inferred latent conversation topic.

Therefore, the Context-Attention architecture is able to manipulate the generation process of the characters in LSTM model. That explains why Titanic and James have higher weights. The contextual attention helps generate domain-adaptive sentences. The Context-Attention architecture is also considered to be flexible and efficient, since such a gated attention works similarly to a standard soft attention and is able to simulate a hard attention in extreme case at the same time.

### Robust Chatting

While chatting may be considered along four criteria of coherency, relevancy, context-independence and non-repetitiveness for judging a good conversation, at the end of this article, Applicant notes another dimension of conversation is important: robustness.

No matter how well a system can chat, if the chatting works only along a very narrow pathway, and the chatbot does not tolerate any variations, the user experience may be very bad. This problem has been troubling template-based chatting systems as such systems may be too restrictive, and keyword-based (or bag of words) systems may have too many false positives.

The described context-attention architecture may solve this problem, as the following experiment indicates:

| | | |
|---|---|---|
| Human | [symbol] | What do I do if I am thirsty |
| Machine | [symbol] | Drink water |
| Human | [symbol] | What do I do if I am a bit thirsty |
| Machine | [symbol] | Drink more water |
| Human | [symbol] | I x a bit thirsty, what do I do |
| Machine | [symbol] | Drink more water |
| Human | [symbol] | I come a bit thirsty, what do I do |
| Machine | [symbol] | Drink more water |
| Human | [symbol] | I China a bit thirsty, what do I do |
| Machine | [symbol] | Drink more water |
| Human | [symbol] [symbol] | I Beijing a bit thirsty China, what do I do |
| Machine | [symbol] | Drink (a Chinese brand of) Coke. |
| Human | [symbol] [symbol] | butterfly I Beijing a bit thirsty, what do I do China |
| Machine | [symbol] | Drink a bit water |
| Human | [symbol] [symbol] | butterfly I Beijing a bit hungry, what do I do China |
| Machine | [symbol] | Eat something |
| Human | [symbol] [symbol] | butterfly in Beijing are there any what do I do China |
| Machine | [symbol] [symbol] | Yes there are (butterflies), in Beijing |

A domain-adaptive and diverse conversation generation approach is provided, wherein a CNN-encoder is introduced to infer latent topics of source sentences to seq2seq models. Various external memory structures for decoder considering context are provided; and Applicants were able to determine that the gated attention mechanism is an efficient mechanism to capture the contextual information, which reflects in the generated responses.

These contexts are trained from large-scale question-answer pairs with category information. Applicants verified experimentally that the architectures described were able to outperform traditional seq2seq models on perplexity tests.

In addition, the context-attention approach also tolerates variations of the input questions, which greatly reduce the labour in traditional rule-based methods and the errors in statistical methods.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

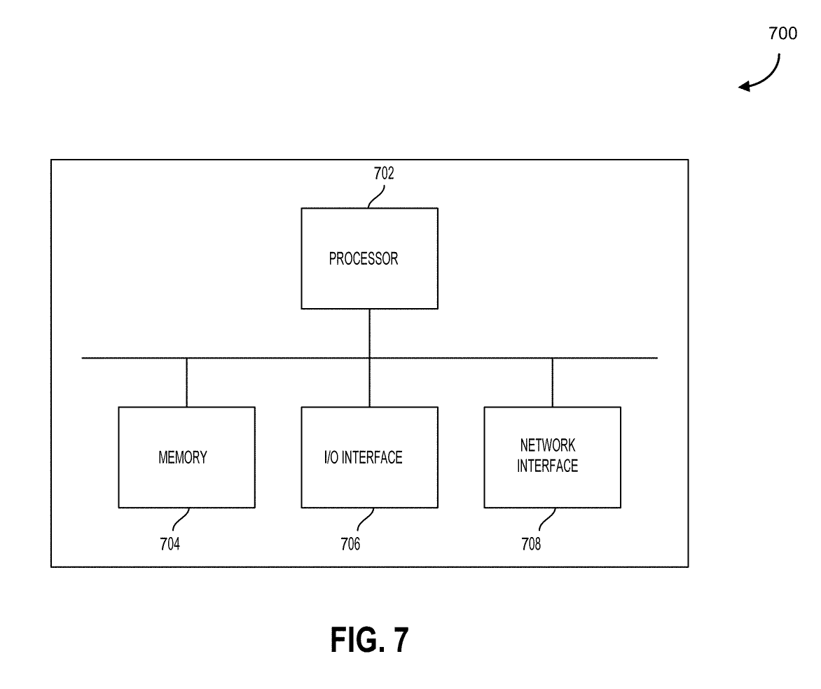

FIG. 7 is a schematic diagram of computing device 700, exemplary of an embodiment. As depicted, computing device includes at least one processor 702, memory 704, at least one I/O interface 706, and at least one network interface 708.

Processor 702 may be an Intel or AMD x86 or x64, PowerPC, ARM processor, or the like. Memory 704 may include a suitable combination of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 706 enables computing device 700 to interconnect with one or more input devices, such as a keyboard, mouse, camera, touch screen and a microphone, or with one or more output devices such as a display screen and a speaker.

Each network interface 708 enables computing device 700 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. W-Fi, WMAX), SS7 signaling network, fixed line, local area network, wide area network, and others, including any combination of these.

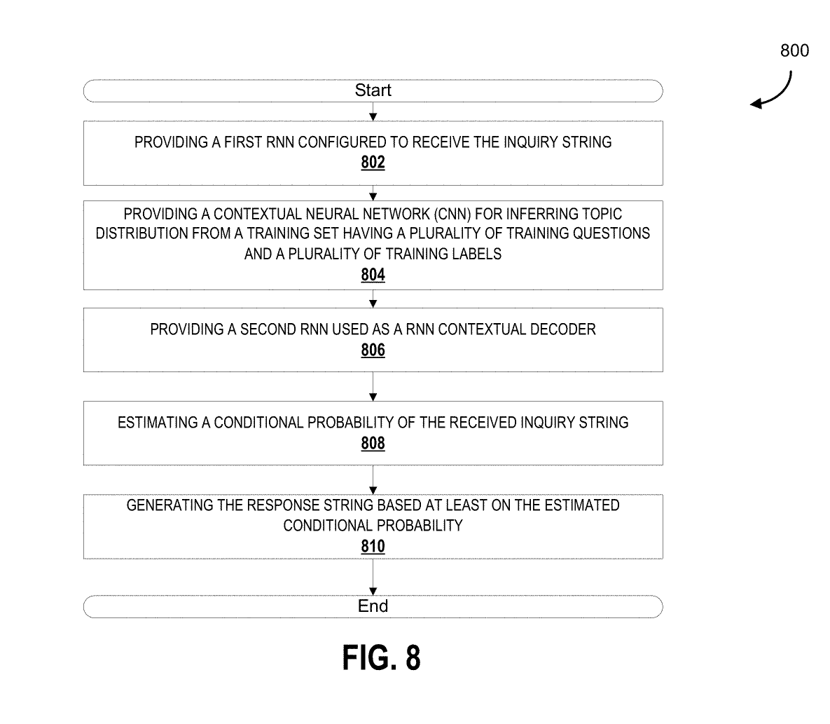

FIG. 8 is an example method 800 for generating a response string based at least on a received inquiry string using a recurrent neural network (RNN) encoder-decoder architecture to improve a relevancy of the generated response string by adapting the generated response based on an identified probabilistic latent conversation domain.

Example steps are shown, and there may be different, alternate, less, more, steps and the examples are provided as non-limiting embodiments.

At 802, a first RNN is provided that is configured to receive the inquiry string as a sequence of vectors x and to encode a sequence of symbols into a fixed length vector representation, vector c.

At 804, a contextual neural network (CNN) is provided for inferring topic distribution from a training set having a plurality of training questions and a plurality of training labels, the CNN configured to extract word features, compute syntactic features and infer semantic representation based on interconnections derived from the training set to generate a fixed length topic vector representation of a probability distribution in a topic space, the topic space inferred from a concatenated utterance of historical conversation.

At 806, a second RNN used as a RNN contextual decoder is provided for estimating a conditional probability distribution of a plurality of responses, the second RNN configured to receive the vector c and the fixed length topic vector representation of the probability distribution in a topic space.

At 808, the RNN contextual decoder applies a layered gated-feedback mechanism arranged in a context-attention architecture to recursively apply a transition function to one or more hidden states for each symbol of the vector c, estimating a conditional probability of the received inquiry string.

In some embodiments, the one or more gates of the context-attention architecture are configured to automatically determine which words of the received inquiry string to augment and which to eliminate based on the vector c. For each word of the response string, the context-attention architecture estimates a conditional probability of a target word yᵢ defined using at least a decoder state sᵢ₋₁, the context vector cᵢ and the last generated word yᵢ₋₁.

At 810, RNN contextual decoder generates the response string based at least on the estimated conditional probability. For example, a response string is generated based on selecting each target word y, having a greatest conditional probability.

While the computer-generated response string may not be entirely accurate (as noted in the examples), there is improved contextual awareness that is provided through the specially configured neural network context-attention architecture, which may aid in providing at least improved information in the computer-generated response strings. Accordingly, improved contextual approximation to human conversation may be evidenced by way of the response strings.

As can be understood, the examples described above and illustrated are intended to be exemplary only.

What is claimed is:

1. A computer-implemented apparatus for generating a response string based at least on a received inquiry string using a recurrent neural network (RNN) encoder-decoder architecture adapted to improve a relevancy of the generated response string by adapting the generated response based on an identified probabilistic latent conversation domain, the apparatus comprising:
a first RNN configured to receive the inquiry string as a sequence of vectors x and to encode a sequence of symbols into a fixed length vector representation, vector c;
a contextual neural network (CNN) pre-configured for inferring topic distribution from a training set having a plurality of training questions and a plurality of training labels, the CNN configured to:
extract, from the sequence of vectors x, one or more word features;
generate syntactic features from the one or more word features; and
infer semantic representation based on interconnections derived from the training set and the syntactic features to generate a fixed length topic vector representation of a probability distribution in a topic space, the topic space inferred from a concatenated utterance of historical conversation and representative of the identified probabilistic latent conversation domain; and
a second RNN used as a RNN contextual decoder for estimating a conditional probability distribution of a plurality of responses, the second RNN configured to:
receive the vector c and the fixed length topic vector representation of the probability distribution in the topic space;
apply a layered gated-feedback mechanism arranged in a context-attention architecture to recursively apply a transition function to one or more hidden states for each symbol of the vector c to generate a context vector cᵢ at each step, one or more gates of the context-attention architecture configured to automatically determine which words of the received inquiry string to augment and which to eliminate based on the vector c;
for each word of the response string, estimate a conditional probability of a target word yᵢ defined using at least a decoder state sᵢ₋₁, the context vector cᵢ, and the last generated word yᵢ₋₁; and
generate the response string based at least on selecting each target word yᵢ having a greatest conditional probability.

2. The computer-implemented apparatus of claim 1, wherein the CNN is an encoder including at least a convolutional layer with multiple filters, a K-max pooling layer, a convolutional layer capturing sequential features, a max-over-time pooling layer, and a fully connected layer.

3. The computer-implemented apparatus of claim 1, wherein the context-attention architecture is configured to provide a gated layer where a gated hidden unit is applied having the relation:
\ddot{h}ₜ=(1−zₜ)∘hₜ+zᵢ∘\tilde{h}ₜ
where,
\tilde{h}ₜ=tanh(Wₕ[rᵢ∘hₜ]+W_{ch}^{h}cₕ)
zₜ=σ(W_{z}sₜ+W_{ch}^{z}cₕ)
rₜ=σ(Wᵣsₜ+W_{ch}^{r}cₕ)
, and Wₕ,W_{z},Wᵣ∈ [symbol] ^{n×n} and W_{ch}^{h},W_{ch}^{z},W_{ch}^{r}∈R^{n×T} are weights.

4. The computer-implemented apparatus of claim 3, wherein the hidden state s is computed by the relation:
sₜ=oₜ∘tanh(Cᵢ)
Cᵢ=fₜ∘Cₜ₋₁+iₜ∘tanh(W_{Ch}sₜ₋₁+W_{Cy}e(yᵢ)+Ccᵢ)
fₜ=σ(W_{fh}sₜ₋₁+W_{fy}e(yᵢ)+C_{f}cᵢ)
iₜ=σ(Wᵢₕsₜ₋₁+W_{iy}e(yᵢ)+Cᵢcᵢ)
oₜ=σ(W_{ch}sₜ₋₁+W_{oy}e(yᵢ)+Cₒcᵢ)
where C,C_{f},Cᵢ,Cₒ∈ [symbol] ^{n×2n}, W_{Ch},W_{fh},Wᵢₕ,Wₒₕ∈ [symbol] ^{n×n} and W_{Cy},W_{fy},W_{iy},W_{oy}∈ [symbol] ^{n×m} are weights.

5. The computer-implemented apparatus of claim 4, wherein the initial hidden state s₀ is computed by the relation:
s₀=tanh(Wₛh_{T}_{ₓ}),
where Wₛ∈ [symbol] ^{n×n}.

6. The computer-implemented apparatus of claim 5, wherein the context vector cᵢ is recomputed at each step by an alignment model having the relation:
$${c}_{i} = {\sum }_{j = 1}^{{T}_{s}} {α}_{ij} {h}_{j}$$
$$where$$
$${α}_{ij} = \frac{exp ( {e}_{ij} )}{{\sum }_{k = 1}^{{T}_{x}} exp ( {e}_{ik} )}$$
$${e}_{ij} = {v}_{a}^{T} tanh ( {W}_{a} {s}_{i - 1} + {U}_{a} {h}_{j} )$$
, and hⱼ is the j-th annotation in the source sentence, vₐ∈ [symbol] ^{n′},Wₐ∈ [symbol] ^{n′×n} and Uₐ∈ [symbol] n′×2n are weight matrices.

7. The computer-implemented apparatus of claim 6, wherein the recurrent neural network (RNN) encoder-decoder architecture is configured to have a deep output with a single maxout hidden layer.

8. The computer-implemented apparatus of claim 7, wherein the probability of the target word yᵢ is defined using the relation:
p(yᵢ|sᵢ,yᵢ₋₁,cᵢ|)∝exp(yᵢ^{T}Wₒtᵢ)
, where
tᵢ=[max{ [symbol] _{,2j-1}, [symbol] _{,2j}}]_{j=1, . . . , l}^{T}
and [symbol] _{,k} is the k-th element of a vector [symbol] which is computed by [symbol]
=Uₒsᵢ₋₁+VₒEyₜ₋₁+Cₒcᵢ

9. The computer-implemented apparatus of claim 1, wherein a performance score of derived based at least on an evaluation of the response string includes a perplexity score.

10. The computer-implemented apparatus of claim 1, wherein the training set used by the CNN includes collected question-answer pairs extracted from external commercial websites.

11. A computer-implemented method for generating a response string based at least on a received inquiry string using a recurrent neural network (RNN) encoder-decoder architecture to improve a relevancy of the generated response string by adapting the generated response based on an identified probabilistic latent conversation domain, the method comprising:
providing a first RNN configured to receive the inquiry string as a sequence of vectors x and to encode a sequence of symbols into a fixed length vector representation, vector c;
providing a contextual neural network (CNN) pre-configured for inferring topic distribution from a training set having a plurality of training questions and a plurality of training labels, the CNN configured to:
extract, from the sequence of vectors x, one or more word features;
generate syntactic features from the one or more word features; and
infer semantic representation based on interconnections derived from the training set and the syntactic features to generate a fixed length topic vector representation of a probability distribution in a topic space, the topic space inferred from a concatenated utterance of historical conversation and representative of the identified probabilistic latent conversation domain; and
providing a second RNN used as a RNN contextual decoder for estimating a conditional probability distribution of a plurality of responses, the second RNN configured to:
receive the vector c and the fixed length topic vector representation of the probability distribution in the topic space;
apply a layered gated-feedback mechanism arranged in a context-attention architecture to recursively apply a transition function to one or more hidden states for each symbol of the vector c to generate a context vector c, at each step, one or more gates of the context-attention architecture configured to automatically determine which words of the received inquiry string to augment and which to eliminate based on the vector c;
for each word of a response string, estimate a conditional probability of a target word yᵢ defined using at least a decoder state sᵢ₋₁, the context vector cᵢ, and the last generated word yᵢ₋₁; and
generate the response string based at least on selecting each target word y, having a greatest conditional probability; and
for each word of the response string, estimating a conditional probability of a target word yᵢ defined using at least a decoder state sᵢ₋₁, the context vector cᵢ, and the last generated word yᵢ₋₁; and
generating the response string based at least on selecting each target word yᵢ having a greatest conditional probability.

12. The computer-implemented method of claim 11, wherein the CNN is an encoder including at least a convolutional layer with multiple filters, a K-max pooling layer, a convolutional layer capturing sequential features, a max-over-time pooling layer, and a fully connected layer.

13. The computer-implemented method of claim 11, wherein the context-attention architecture provides a gated layer where a gated hidden unit is applied having the relation:
\ddot{h}ₜ=(1−zᵢ)∘hₜ+zₜ∘\tilde{h}ₜ
where,
\tilde{h}ᵢ=tanh(Wₕ[rᵢ∘hₜ]+W_{ch}^{h}cₕ)
zₜ=σ(W_{z}sₜ+W_{ch}^{z}cₕ)
rₜ=σ(Wᵣsₜ+W_{ch}^{r}cₕ)
, and Wₕ,W_{z},Wᵣ∈ [symbol] ^{n×n} and W_{ch}^{h},W_{ch}^{z},W_{ch}^{r}∈R^{n×T} are weights.

14. The computer-implemented method of claim 13, wherein the hidden state s is computed by the relation:
sₜ=oₜ∘tanh(Cᵢ)
Cᵢ=fₜ∘Cₜ₋₁+iₜ∘tanh(W_{Ch}sₜ₋₁+W_{Cy}e(yᵢ)+Ccᵢ)
fₜ=σ(W_{fh}sₜ₋₁+W_{fy}e(yᵢ)+C_{f}cᵢ)
iₜ=σ(Wᵢₕsₜ₋₁+W_{iy}e(yᵢ)+Cᵢcᵢ)
oₜ=σ(W_{ch}sₜ₋₁+W_{oy}e(yᵢ)+Cₒcᵢ)
where C,C_{f},Cᵢ,Cₒ∈ [symbol] ^{n×2n}, W_{Ch},W_{fh},Wᵢₕ,Wₒₕ∈ [symbol] ^{n×n} and W_{Cy},W_{fy},W_{iy},W_{oy}∈ [symbol] ^{n×m} are weights.

15. The computer-implemented method of claim 14, wherein the initial hidden state s₀ is computed by the relation:
s₀=tanh(Wₛh_{T}_{ₓ}),
where Wₛ∈ [symbol] ^{n×n}.

16. The computer-implemented method of claim 15, wherein the context vector cᵢ is recomputed at each step by an alignment model having the relation:
$${c}_{i} = {\sum }_{j = 1}^{{T}_{s}} {α}_{ij} {h}_{j}$$
$$where$$
$${α}_{ij} = \frac{exp ( {e}_{ij} )}{{\sum }_{k = 1}^{{T}_{x}} exp ( {e}_{ik} )}$$
$${e}_{ij} = {v}_{a}^{T} tanh ( {W}_{a} {s}_{i - 1} + {U}_{a} {h}_{j} )$$
, and hⱼ is the j-th annotation in the source sentence vₐ∈ [symbol] ^{n′}, Wₐ∈ [symbol] ^{n′×n} and Uₐ∈ [symbol] n′×2n are weight matrices.

17. The computer-implemented method of claim 16, wherein the recurrent neural network (RNN) encoder-decoder architecture is configured to have a deep output with a single maxout hidden layer.

18. The computer-implemented method of claim 17, wherein the probability of the target word yᵢ is defined using the relation:
p(yᵢ|sᵢ,yᵢ₋₁,cᵢ|)∝exp(yᵢ^{T}Wₒtᵢ)
, where
tᵢ=[max{ [symbol] _{,2j-1}, [symbol] _{,2j}}]_{j=1, . . . , l}^{T}
and [symbol] _{,k} is the k-th element of a vector [symbol] which is computed by [symbol]
=Uₒsᵢ₋₁+VₒEyₜ₋₁+Cₒcᵢ

19. The computer-implemented method of claim 11, wherein a performance score of derived based at least on an evaluation of the response string includes a perplexity score.

20. A non-transitory computer readable medium storing machine-readable instructions which when executed by a processor, cause the processor to perform a method for generating a response string based at least on a received inquiry string using a recurrent neural network (RNN) encoder-decoder architecture to improve a relevancy of the generated response string by adapting the generated response based on an identified probabilistic latent conversation domain, the method comprising:
providing a first RNN configured to receive the inquiry string as a sequence of vectors x and to encode a sequence of symbols into a fixed length vector representation, vector c;
providing a contextual neural network (CNN) pre-configured for inferring topic distribution from a training set having a plurality of training questions and a plurality of training labels, the CNN configured to:
extract, from the sequence of vectors x, one or more word features;
generate syntactic features from the one or more word features; and
infer semantic representation based on interconnections derived from the training set and the syntactic features to generate a fixed length topic vector representation of a probability distribution in a topic space, the topic space inferred from a concatenated utterance of historical conversation and representative of the identified probabilistic latent conversation domain; and
providing a second RNN used as a RNN contextual decoder for estimating a conditional probability distribution of a plurality of responses, the second RNN configured to:
receive the vector c and the fixed length topic vector representation of the probability distribution in the topic space;
apply a layered gated-feedback mechanism arranged in a context-attention architecture to recursively apply a transition function to one or more hidden states for each symbol of the vector c to generate a context vector cᵢ at each step, one or more gates of the context-attention architecture configured to automatically determine which words of the received inquiry string to augment and which to eliminate based on the vector c;
for each word of a response string, estimate a conditional probability of a target word yᵢ defined using at least a decoder state sᵢ₋₁, the context vector cᵢ, and the last generated word yᵢ₋₁; and
generate the response string based at least on selecting each target word yᵢ having a greatest conditional probability; and
for each word of the response string, estimating a conditional probability of a target word yᵢ defined using at least a decoder state sᵢ₋₁, the context vector cᵢ, and the last generated word yᵢ₋₁; and
generating the response string based at least on selecting each target word yᵢ having a greatest conditional probability.
